(19) United States
(12) Patent Application Publication
(10) Pub. No.: US 2003/0219128 A1
(43) Pub. Date: Nov. 27, 2003

(54) Telephone subscriber unit and a semiconductor device for use in or with a telephone subscriber unit

(75) Inventor: Thomas Luby, Alan Bullock Close (GB)

Correspondence Address: James M. Bagarazzi, DORITY & MANNING, P.A., P.O. BOX 1449, GREENVILLE, SC, 29602-1449, US

(73) Assignee: Zarlink Semiconductor Limited

(21) Appl. No.: 10/371,970

(22) Filed: Feb. 21, 2003

(30) Foreign Application Priority Data
Feb. 22, 2002 (GB) 0204206.7

(51) Int. Cl. H04K 1/00

(52) U.S. Cl. 380/255; 713/153

(57) ABSTRACT

A communication system includes a Voice over Internet Protocol (VoIP) subscriber unit coupled via a modem to a broadcast environment such as an Internet Protocol (IP) network, which may be the Internet. The VoIP subscriber unit has an input and output interface for connection to the network, the unit being arranged to transmit and receive voice signals to and from the network system via the interface as digital data packets. The VoIP subscriber unit includes a voice encoder/decoder arranged to convert analog voice signals to digital data packets and vice-versa, an encryptor/decryptor coupled to the encoder/decoder and to the interface and arranged to encrypt data packets received from the encoder/decoder and to decrypt digital data packets received from the interface in real time, and a storage medium. Encryption and decryption is performed using an encryption key stored in the storage medium. A semiconductor device for incorporation in the VoIP subscriber unit is also disclosed.

### CROSS-REFERENCE TO RELATED APPLICATIONS

The present application claims priority to currently pending United Kingdom Patent Application number 0204206.7, filed on Feb. 22, 2002.

### STATEMENT REGARDING FEDERALLY SPONSORED RESEARCH OR DEVELOPMENT

N/A

### BACKGROUND OF THE INVENTION

This invention relates to voice signal transmission over a network between transmitting and receiving devices and, in particular, to a telephone subscriber unit for coupling to a network system.

Telephone calls over a public switched telecommunications network system may be transmitted as analog or digital signals. Such a digital signal may take the form of a stream of data packets each having encoded within them, among other things, a sender address and a destination address, as well as voice signal data encoded using a known encoding standard such as a G711 or G723 codec. It is also known to transmit such digitally encoded voice signals over local networks and over the Internet using the Internet Protocol (IP).

### SUMMARY OF THE INVENTION

Additional aspects and advantages of the invention will be set forth in part in the description that follows, and in part will be obvious from the description, or may be learned by practice of the invention. The aspects and advantages of the invention may be realized and attained by means of the instrumentalities and combinations particularly pointed out in the appended claims.

According to one aspect of the present invention, a telephone subscriber unit having an input and output interface for connection to a network system is arranged to transmit and receive voice signals to and from the network system via the interface as digital data packets, wherein the subscriber unit comprises a voice encoder/decoder arranged to convert analog voice signals to digital data packets and vice-versa, an encryptor/decryptor coupled to the encoder/decoder and to the interface and arranged to encrypt data packets received from the encoder/decoder and to decrypt digital data packets received from the interface in real time, and a storage medium, the encryption and decryption being performed using an encryption key stored in the storage medium.

The encryptor/decryptor may in some embodiments correspond to a hardwired logic array incorporated in a semiconductor device forming part of the subscriber unit and configured to implement a DES algorithm or AES algorithm. The voice signal encoder/decoder may be included in the semiconductor device, with signals passing between the encoder/decoder and the encryptor/decryptor via a time-division multiplexing state.

The semiconductor device may also include a USB port and a DSP port for respectively receiving digital video and music signals.

The semiconductor device may further comprise a data processor and a hardware accelerator, the latter constituting the encryptor/decryptor in some exemplary embodiments.

The interface is typically an Ethernet interface, and the unit may be configured to transmit and receive the digital data packets using the Internet Protocol (IP).

According to another aspect of the invention, a semiconductor device for incorporation in a telephone subscriber unit or in a modem designed to receive analog voice signals comprises an input and output interface for connection to a network system, a voice encoder/decoder arranged to convert analog voice signals to digital data packets and vice-versa, an encryptor/decryptor coupled to the encoder/decoder and to the interface and a storage medium, the encryption and decryption being performed in real time using an encryption key stored in the storage medium, whereby the device is capable of transmitting and receiving digital voice signals to and from the network system via the interface as the digital data packets.

The accompanying drawings, which are incorporated in and constitute a part of this specification, illustrate at least one presently preferred embodiment of the invention as well as some alternative embodiments. These drawings, together with the description, serve to explain the principles of the invention but by no means are intended to be exhaustive of all of the possible manifestations of the invention.

### BRIEF DESCRIPTION OF THE DRAWINGS

FIG. 1 is a diagram illustrating a communication system including an exemplary subscriber unit in accordance with the invention;

FIG. 2 is a functional block diagram of an exemplary processor device forming part of the subscriber unit;

FIG. 3 is a simplified block diagram of the processor device shown in FIG. 2;

FIG. 4 is a block diagram of an exemplary hardware accelerator incorporated in the processor device of FIG. 2; and

FIG. 5 is an exemplary expanded communication system in accordance with the invention.

### DETAILED DESCRIPTION OF THE PREFERRED EMBODIMENTS

Reference now will be made in detail to the presently preferred embodiments of the invention, one or more examples of which are illustrated in the accompanying drawings. Each example is provided by way of explanation of the invention, which is not restricted to the specifics of the examples. In fact, it will be apparent to those skilled in the art that various modifications and variations can be made in the present invention without departing from the scope or spirit of the invention. For instance, features illustrated or described as part of one embodiment, can be used on another embodiment to yield a still further embodiment. Thus, it is intended that the present invention cover such modifications and variations as come within the scope of the appended claims and their equivalents. The same numerals are assigned to the same components throughout the drawings and description.

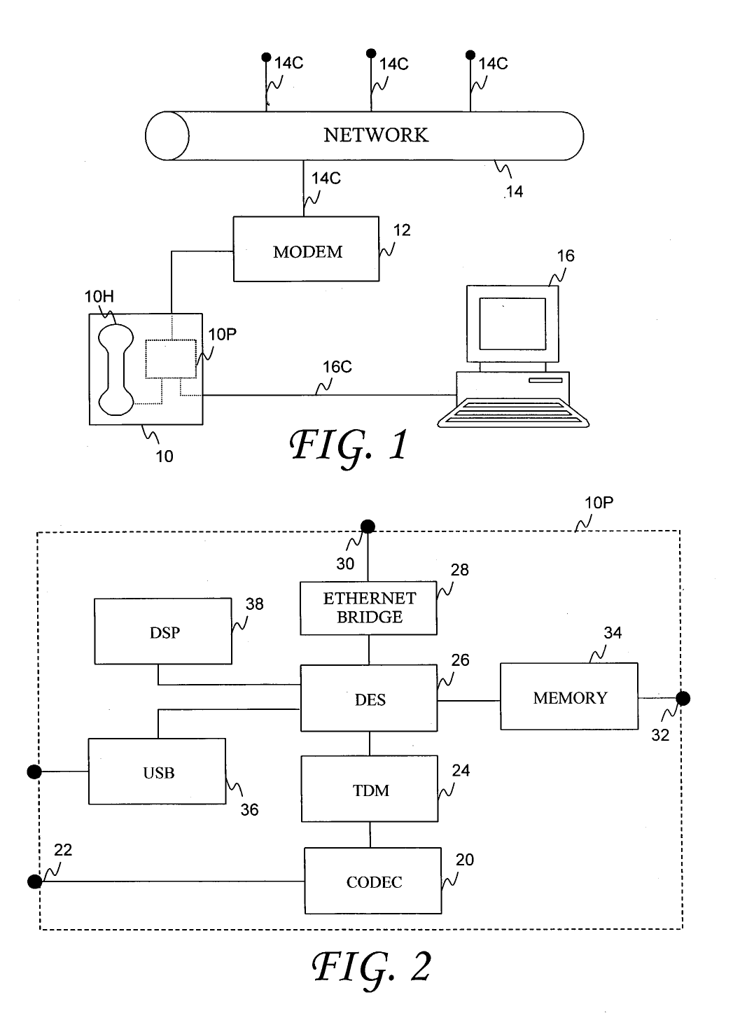

Referring to FIG. 1, a communication system has a Voice over Internet Protocol (VoIP) subscriber unit 10 coupled via a modem 12 to a broadcast environment such as an Internet Protocol (IP) network 14, which may be the Internet. As shown in FIG. 1, the network 14 has a plurality of user connections 14C, one of which is connected to the modem 12 which, in this example, is a cable modem.

Incorporated as part of the VoIP subscriber unit 10 is a handset 1 OH and a VoIP processor device 10P. Analog voice signals from the handset 10H are fed to the processor device 10P where they are encoded into digital data packets for transmission over the IP network 14 via modem 12. The transmitted data packets include, among other elements, a sender's IP address associated with the connection 14C between the network 14 and the subscriber unit 10, a destination IP address associated with another connection 14C, and the digitized voice data. The processor device 10P is arranged such that an initial part of the packet transmission includes a conventional log-in password prompt. Similarly encoded voice signals may be received from another, remote subscriber unit (not shown) connected to the network 14, digital data packets being received with an initial password prompt entered at the remote subscriber unit corresponding to the other connection 14C. The received data packets pass through modem 12 to the processor device 1 OP where they are decoded to deliver a corresponding analog voice signal to the handset 10H. In this way, voice communication may be carried out over the IP network between the linked subscriber units.

Processor device 10P may operate as a stand-alone device or may be controlled by a computer (PC) 16 via the connection 16C.

In this example, the modem 12 may be a cable modem. The modem may be separate from the subscriber unit 10, as shown in FIG. 1, or may be incorporated as part of the unit 10.

The processor device 1 OP is shown in more detail in FIG. 2. It will be understood that the processor device elements shown in FIG. 2 may be interconnected hardware circuits, as shown, or they may, at least in part, be functional elements of a program performed within the processor device 10P. In the latter case, the illustrated elements are to be regarded as interrelated functions only. PC 16 is shown simply as an illustration of how the Ethernet bridge in processor device 10P may be used to provide for transmission of not only voice signals to the IP network, but also signals generated by the PC.

Referring to FIG. 2, the processor device 10P has an encoder/decoder (codec) 20 coupled to an analog signal port 22 connected to the handset 10H (FIG. 1) for bidirectional transmission of analog voice signals. This encoder/decoder 20 typically operates according to the G711 or G723 codecs. An exemplary embodiment of encoder/decoder 20 is a codec chip configured to perform analog-to-digital (A/D) conversion and digital-to-analog (D/A) conversion. Alternatively, the conversion may be performed by a DSP or processor configured to execute the G711, G723 or other codecs. Exemplary A/D and D/A conversion algorithms are well known to one of skill in the art.

Digital data packets generated in real-time by codec 20 are fed, using a TDM-type protocol, to a time-division multiplexer (TDM) module 24 and then to an encryptor/decryptor 26 which, in this embodiment, encrypts the data packets according to the known Data Encryption Standard (DES), the encrypted data packet being fed via a network interface in the form of an Ethernet bridge 28 to a network input/output port 30. The codec 20 may be separate from the processor device 10P in alternative embodiments.

The Ethernet bridge 28 may also serve as a network interface for PC 16 coupled to a PC port 32.

Encrypted data packets from a remote subscriber unit are fed from network port 30 through the Ethernet bridge 28 and thence to the encryptor/decryptor 26 where they are decrypted, preferably using the same encryption key as used for encrypting transmitted packets. The decrypted packets are then de-multiplexed in TDM module 24 and converted to an analog voice signal in codec 20 for delivery to the handset port 22.

Encryption and decryption are performed in real time by the encryptor/decryptor 26, the encryption key or keys being provided in a storage medium such as memory 34, which is coupled to the DES stage 26. Memory may include RAM, ROM, and/or other specific types of memory as would be appreciated by one of skill in the art. An example of encryptor/decryptor 26 corresponds to a hardware accelerator implementation, which includes a hard-wired logic array as discussed later in further detail. Another encryptor/decryptor example corresponds to a software algorithm stored in an internal or external memory and executed by a DSP or processor.

In this embodiment, the processor device 10P includes a USB interface 36 for transmission of encrypted and decrypted signals between the IP network and additional peripheral devices, such as video and audio units for generating and/or receiving picture and music signals. The USB interface 36 is a high-speed interface for video or audio transfer (including music). The processor device 10P includes a digital signal processor (DSP) 38 which may be used to emulate other codecs (e.g., fax data) or to provide audio effects.

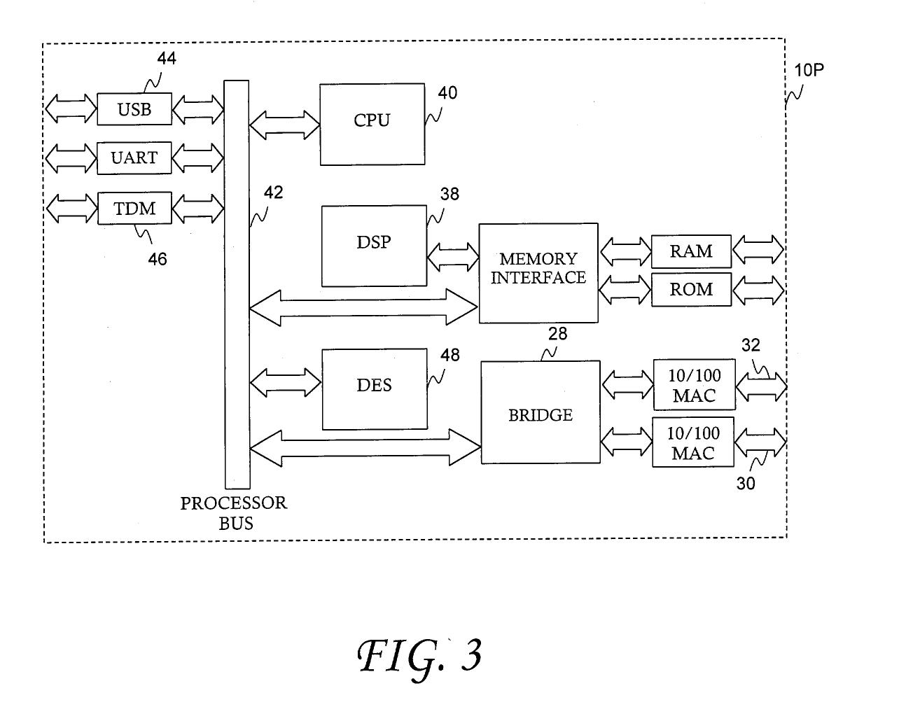

A preferred embodiment of the processor device 10P, in the form of a VoIP ASIC is shown in simplified form in FIG. 3. The processor device 10P, in structural terms, comprises a CPU 40 coupled to a processor bus 42 for exchanging signals with the Ethernet bridge 28, as well as the USB and TDM interfaces 44, 46. Other interfaces, such as a Universal Asynchronous Receiver-Transmitter (UART) interface may also be coupled to processor bus 42. DES unit 48 here includes the encryptor/decryptor 26 and the memory 34 (see FIG. 2). Additional memory modules, such as RAM and ROM memory, may be coupled to DSP 38 through a memory interface. Ethernet bridge 28 may be coupled to a modem or other interface via network input/output port 30. Ethernet bridge 28 may be coupled to a PC via PC port 32. Both ports 30 and 32 may be interfaced with, for example, a 10/100 Media Access Controller (MAC).

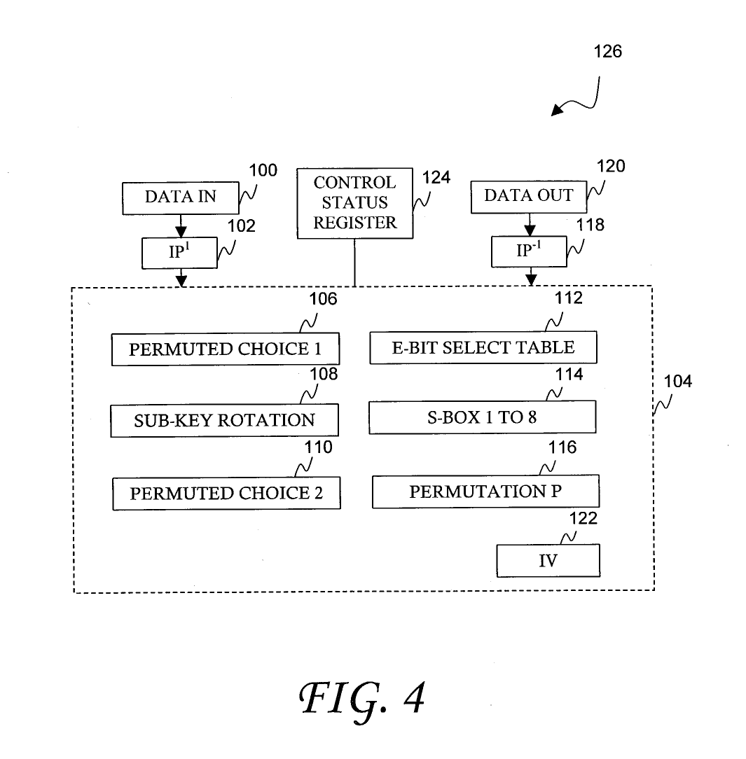

Referring to FIG. 4, a DES hardware accelerator 126 implements the DES algorithm. For a detailed explanation of the DES algorithm, see “Specifications for the Data Encryption Standard (DES)” in United States Federal Information Processing Standards Publication 46-3 dated Oct. 25, 1999, which is hereby incorporated herein by reference for all purposes. This publication describes how the DES algorithm may be used to encipher blocks of data each consisting of 64 bits under control of a 64-bit key. Both encryption and decryption processes comprise subjecting the input block to an initial permutation, then to a complex key-dependent computation, and finally, to a permutation which is the inverse of the initial permutation. The key-dependent computation is performed by the combination of a function called the cipher function which takes permuted selections of the key and applies each selection to an exclusive-OR combination with a data block formed by passing part of the permuted-input block through a first mapping function, feeding the result to a second mapping function and then subjecting the output to a further permutation function. This process is performed a number of times with different permuted selections of the key before performing the inverse permutation mentioned above.

In the present embodiment, the DES algorithm is implemented in hard-wired logic within the ASIC described above with reference to FIG. 3. Accordingly, referring to FIG. 4, the hardware accelerator 126 includes an input register 100, a logic state 102 for performing the initial permutation (IP¹), a logic array 104 for performing the cipher function (f) and for deriving the key schedule (KS). The key schedule comprises a series of permuted selections of the key obtained by subjecting the key (stored in memory 34—see FIG. 2) to a first permuted choice determined by a stored table 106 (Permuted Choice 1 or PC1). The first permutation output is then subjected to a sub-key rotation formed by subjecting the output to one or two shifts, the number of shifts depending on the number of the respective iteration of the permuted input block in the cipher function f. The output of the rotation is passed through a second permutation choice which is a mapping function defined by a second table 110 (Permuted Choice 2 or PC2), thereby yielding a different permuted selection for each successive iteration of the cipher function. In the cipher function itself, the first mapping function is performed by selecting the permuted input block bits in an order according to a selection table 112 (defined as E), the output of the exclusive-OR function referred to above, i.e., the exclusive-OR combination of the first mapping output and the respective permuted key selection, is subjected to the second mapping function determined by eight unique selection functions S₁ to S₈ determined by eight stored tables 114. The final part of each cipher function iteration, the application of a permutation function (P), is defined by a table 116.

The logic array then performs an exclusive operation recombining the cipher function input parts before commencing a second iteration with the next permuted selection of the key. The cipher function is repeated 16 times and the output fed to a logic state 118 for performing the inverse permutation (IP⁻¹), the output of which is placed in an output register 120.

A stored initialization vector 122 (IV) is stored for use in implementing the enhanced triple-DES encryption/decryption standard in the logic array 104, if required. Settings for performing the DES algorithm are set in the control/status register 124.

In this embodiment, therefore, implementation of the DES algorithm may be performed as the following steps:

A1) Write the Control register 124 to set DES mode (single or triple mode) and whether to encrypt or decrypt

A2) Write the 64-bit key (2×32-bit register writes)

A3) Write the 64-bit Initialization Vector IV (triple DES mode only) (2×32-bit)

A4) Write the 64-bit IP value to encrypt or decrypt (2×32-bit). This write triggers the hardware accelerator to start.

1 clock cycle elapsed.

For R=1 to 16

B1) Rotate the key either one or two places depending on the value of R

B2) Generate a subkey by passing through a standard mapping function (PC2)

B3) Split the IP into two halves. Take the least significant bits and apply an E-bit selection table (another mapping function)

B4) Pass through an S-Box function which maps 6-bit values into 4-bit values

B5) Pass through another 1-to-1 mapping function (PERMUTATION)

B6) XOR the result with the most significant bits of the data from step 3

1 clock cycle elapsed

Next R

R here is the number of the iteration of the initial permutation IP in the cipher function f. The permutation IP⁻¹ applied to the preoutput block arising from the sixteen cipher function applications is the inverse of the initial permutation IP. Consequently, to decrypt, it is only necessary to apply the same algorithm to an encrypted message clock, taking care at each iteration of the computation of the same block of key bits is used during decryption as was used during encryption of the block.

It should be appreciated that the above encryption/decryption algorithm is presented for exemplary purposes only. Different specific algorithms may include varied combinations of the aforementioned steps. For instance, encryption/decryption algorithms may include any selected combination of such operations as rotation, mapping, addition, use of look-up tables, as well as other cryptography-related steps as would be appreciated by one of ordinary skill in the art.

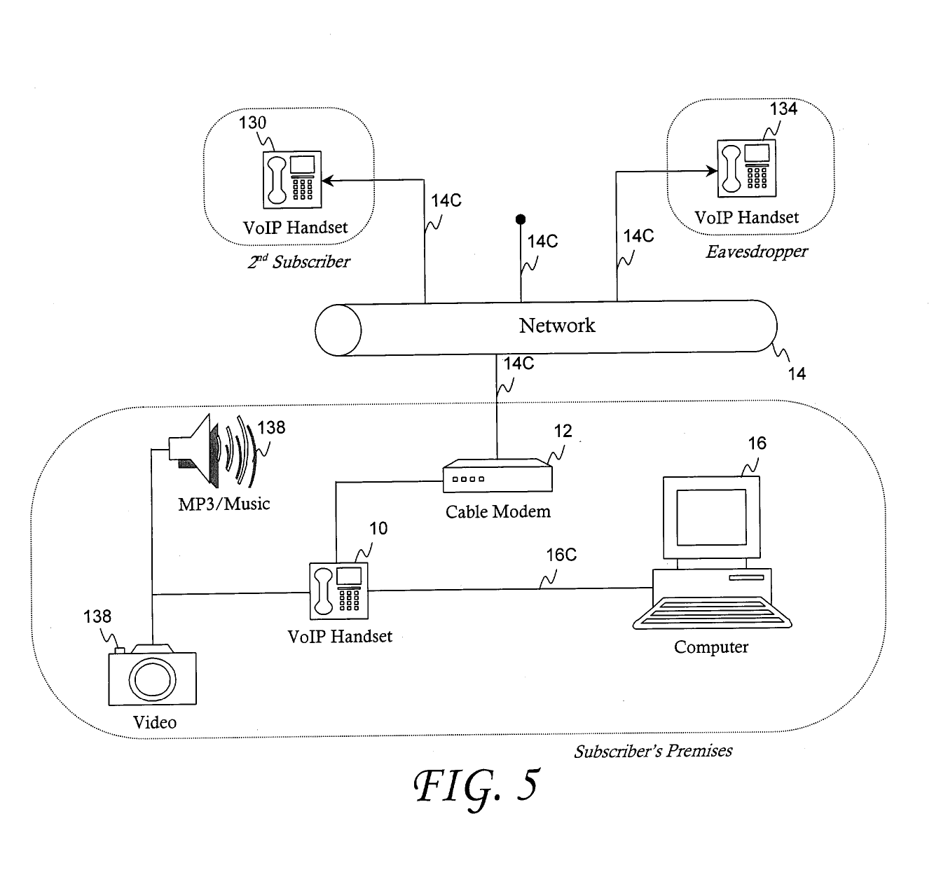

Referring to FIG. 5, a VoIP subscriber unit 10 as described above may be connected in a communications system in which, at the subscriber's premises, facilities are provided for transmitting and receiving music and video signals, and in which voice signals are exchanged with a second subscriber unit 130, also connected to the network via one of the network connections 14C, as shown. Encryption of voice signals in the manner described above in the first subscriber unit 10 (or in the modem 12) is matched by corresponding decryption in the second subscriber 130. Likewise, the second subscriber unit 130 is arranged to encrypt signals which can then be decrypted by the encryptor/decryptor of the first subscriber unit 10. Accordingly, if the third subscriber unit 134 connected to the network is operated as an eavesdropper, the voice signals passing between the first and second subscriber units 10 and 130 cannot be understood. The eavesdropper may operate a “packet sniffer” program running on a network-attached device that passively receives all data-link-layer frames passing the network interface between the subscriber unit 134 and network 14. In a broadcast environment such as an IP network, the packet sniffer could be configured to receive all frames transmitted from or to all hosts in a local area network. Any host with, for instance, an Ethernet card could serve as a packet sniffer since the Ethernet interface card needs only to be set to a so-called “promiscuous mode” to receive all passing Ethernet frames. These frames can then be passed on to application programs for extracting application-level data. For instance, in the arrangement shown in FIG. 5, a log-in password prompt sent from the first subscriber unit 10 to the second subscriber unit 130, as well as a password entered at the second subscriber unit 130, may be picked up by the eavesdropper subscriber unit 134. It should be noted that the IP address of a receiving subscriber unit will be known to a transmitting subscriber unit. On a network with two VoIP subscriber units, one transmitting and one receiving at a particular instant, a third eavesdropping unit connected to the network and running packet sniffing software would be able to capture all data sent between the other two devices.

The encryption of data in the transmitting subscriber units prevents successful eavesdropping. The eavesdropping unit needs the encryption key used by the other two units. By adopting an encryption standard such as the DES or AES standard, the time needed to break the encryption code generally exceeds the time period during which is it is useful to know about the data being transmitted.

Transmissions over the Internet, an intranet, and other vulnerable networks may be secured in the manner described above.

For real-time encryption, it is preferred that the subscriber unit encryptor/decryptor is implemented in hardware using the hardware accelerator described above. Alternatively, the DES algorithm could be stored in an internal or external memory and executed by a DSP or processor, which may be embedded on a VoIP ASIC. By operating a hardware logic array at a clock rate in excess of 30 MHz, it is possible to perform the encryption and decryption of a digitized voice signal. Packets received for encryption or decryption may be read simultaneously with the algorithm processing operation.

Depending on the nature of additional signals to be encrypted (e.g., music or video signals from an MP3/music peripheral 136 or a video unit 138), a slower clock rate can be employed with parallel execution of the algorithm steps.

This invention also prevents “spoofing” on an IP network. “Spoofing” is a term applied to a situation in which an eavesdropper sets its network address (IP address) to that of the receiving subscriber unit 130 and then initiates a call to the first subscriber unit 10. Subscriber unit 10 responds as if it was communicating with the legitimate second subscriber unit. Encryption in the manner described above prevents the spoofing subscriber unit 134 from imitating the second subscriber unit 130 unless it possesses the key currently used for encryption and decryption of signals between the first unit 10 and the second unit 130.

While at least one presently preferred embodiment of the invention has been described using specific terms, such description is for illustrative purposes only, and it is to be understood that changes and variations may be made without departing from the spirit or scope of the following claims.

What is claimed is:

1. A telephone subscriber unit, comprising:
an input and output interface for connection to a network system, said subscriber unit being arranged to transmit and receive voice signals to and from the network system via said interface as digital data packets;
a voice encoder/decoder arranged to convert analog voice signals to digital data packets and vice-versa;
an encryptor/decryptor coupled to said voice encoder/decoder and to said interface and arranged to encrypt data packets received from said encoder/decoder and to decrypt digital data packets received from said interface in real time; and
a storage medium for storing an encryption key, wherein the encryption key is utilized by said encryptor/decryptor to encrypt and decrypt data packets.

2. A subscriber unit as in claim 1, further comprising a time-division multiplexor coupled between said encoder/decoder and said encryptor/decryptor.

3. A subscriber unit as in claim 1, wherein said encryptor/decryptor is configured to implement an encryption algorithm, the function of which is the result of operations including rotation, mapping, addition and use of look-up tables.

4. A subscriber unit as in claim 1, wherein said subscriber unit is configured to transmit and receive said digital data packets using the Internet Protocol (IP).

5. A subscriber unit as in claim 1, wherein said encryptor/decryptor comprises a hard-wired logic array incorporated in a semiconductor device forming part of said subscriber unit.

6. A subscriber unit as in claim 5, wherein said voice encoder/decoder is included in the semiconductor device.

7. A subscriber unit as in claim 6, wherein the semiconductor device includes a USB port and a DSP port for respectively receiving digital video and music signals.

8. A subscriber unit as in claim 6, wherein the semiconductor device further comprises a data processor and wherein said encryptor/decryptor comprises a hardware accelerator.

9. A subscriber unit as in claim 6, wherein said interface is a bridge interface.

10. A subscriber unit as in claim 6, further comprising a time-division multiplexor coupled between said encoder/decoder and said encryptor/decryptor.

11. A subscriber unit as in claim 6, wherein said encryptor/decryptor is configured to implement an encryption algorithm, the function of which is the result of operations selected from the group consisting of rotation, mapping, addition and use of look-up tables.

12. A subscriber unit as in claim 6, wherein said subscriber unit is configured to transmit and receive said digital data packets using the Internet Protocol (IP).

13. A semiconductor device for incorporation in a telephone subscriber unit or in a modem designed to receive analog voice signals, comprising:
an input and output interface for connection to a network system, whereby said semiconductor device is capable of transmitting and receiving digital voice signals to and from the network system via said interface as digital data packets;
a voice encoder/decoder arranged to convert analog voice signals to digital data packets and vice-versa;
an encryptor/decryptor coupled to said encoder/decoder and to said interface and arranged to encrypt data packets received from said encoder/decoder and to decrypt digital data packets received from said interface in real time; and
a storage medium for storing an encryption key, wherein the encryption key is utilized by said encryptor/decryptor to encrypt and decrypt data packets.

14. A semiconductor device as in claim 13, wherein said encryptor/decryptor comprises a hard-wired logic array.

15. A semiconductor device as in claim 13, further comprising a USB port and a DSP port for receiving digital video and music signals.

16. A semiconductor device as in claim 13, further comprising a data processor, and wherein said encryptor/decryptor comprises a hardware accelerator.

17. A semiconductor device as in claim 13, wherein said input and output interface is a bridge interface.

18. A semiconductor device as in claim 13, further comprising a time-division multiplexor coupled between said encoder/decoder and said encryptor/decryptor.

19. A semiconductor device as in claim 13, wherein said encryptor/decryptor is configured to implement an encryption algorithm, the function of which is the results of operations selected from the group consisting of rotation, mapping, addition and use of look-up tables.

20. A semiconductor device as in claim 13, wherein said semiconductor device is configured to transmit and receive digital data packets using the Internet Protocol (IP).
